(19) United States
(12) Patent Application Publication
(10) Pub. No.: US 2023/0291577 A1
(43) Pub. Date: Sep. 14, 2023

(54) APPARATUS AND METHOD FOR MANAGING DATA CERTIFICATES IN AN ICN NETWORK

(71) Applicant: ELECTRONICS AND TELECOMMUNICATIONS RESEARCH INSTITUTE, Daejeon (KR)

(72) Inventors: Quang Tung THAI, Daejeon (KR); Sae Hyong PARK, Daejeon (KR); Namseok KO, Daejeon (KR)

(73) Assignee: ELECTRONICS AND TELECOMMUNICATIONS RESEARCH INSTITUTE, Daejeon (KR)

(21) Appl. No.: 18/180,465

(22) Filed: Mar. 8, 2023

(30) Foreign Application Priority Data
Mar. 8, 2022 (KR) 10-2022-0029097

(51) Int. Cl. H04L 9/32; H04L 9/40; H04L 67/133; H04L 67/63

(52) U.S. Cl. CPC H04L 9/3268; H04L 63/0823; H04L 67/133; H04L 67/63

(57) ABSTRACT

The present disclosure is related to a device and method for publishing a certificate. The method includes receiving an RPC message including an publishing method from a client; when the client includes request authority, generating a wrapper for each certificate of a bundle and storing the generated wrapper in a database; when the certificate is not a final certificate, initializing a location and counter of a next certificate to be fetched; transmitting a certificate fetching request from the location; when the certificate is a newly fetched certificate, updating the location of the certificate, incrementing a count variable, generating a certificate wrapper for the certificate, and adding the generated certificate wrapper to the database; and when the certificate is reliable, transmitting an RPC response message to the client.

### CROSS-REFERENCE TO RELATED APPLICATION

This application claims priority to and the benefit of Korean Patent Application No. 10-2022-0029097, filed on Mar. 8, 2022, the disclosure of which is incorporated herein by reference in its entirety.

### BACKGROUND

### 1. Field of the Invention

The present disclosure relates to a APPARATUS and method for managing data certificates, and specifically, to a device and method for managing data certificates in an information-centric network (ICN) network.

### 2. DISCUSSION OF RELATED ART

NDN supports network-level data security. A producer signs a data packet and a consumer verifies the signature. An NDN data packet usually contains a link about information used to verify validity of the packet. When a public key signature scheme is used, this information is a certificate of the producer.

A certificate is a binding of a public key and identity, authorized by a digital signature from a Certificate Authority. The subject of the identity must possess a secret key that is paired with the certificate's public key. The secret key is used by the subject (producer) to secure data packets. A data packet is valid when the signature is verified with the public key of a valid certificate. The certificate is valid if it is trusted by the data verifier (consumer) or he can verify its validity.

In NDN, a certificate is also an NDN data packet. When a certificate is trusted by the security model of an application program, it is called a trust anchor. Otherwise, a certificate must be verified in the same way as NDN packet verification. In the special case where the certificate is self-signed, a certificate may be verified by the included public key. In other cases, a certificate is verified by a public key within another connected certificate.

Therefore, when data is desired to be identified in an application program context, it is necessary to identify a certificate chain up to a reliable specific anchor. A collection of these certificate chains is called a certificate bundle. The certificate bundle starts with a certificate used to verify an application program data packet and ends with a certificate trusted by the security model of the application program.

It is necessary for the producer to make the corresponding certificate bundle available to the consumer. Next, it is necessary for the consumer to download all the certificates in the bundle to verify the validity of corresponding data. Accordingly, serving and fetching the certificate bundle is a common pattern for an NDN application program. There is no standardized framework to support development and deployment in this regard. The current practice has the following several problems.

A certificate is identified by a name that is also a hint to its location. The name begins with a namespace owned by the certificate owner. Therefore, the certificate must be served from a corresponding specific namespace. Since the certificate bundle may include certificates, whose names are scattered across several namespaces, the consumer may need to collect certificates as a bundle from different locations. For example, an application certificate whose name begins with/myapp/videos may be hosted in the corresponding namespace and is used to verify a data packet with the same prefix. The certificate is verified by a certificate of a user whose name begins with/etri/users/kimhongki. The user's certificate is verified with the certificate of the organization whose name begins with/etri. Obviously, the producer of /myapp/videos cannot serve the last two certificates because they do not possess the namespace. Therefore, hosting should be relied on other repositories of the namespace of/etri. This method is prone to failure because the entire verification process may be interrupted when a single certificate in the bundle cannot be fetched.

These concerns lead to a common practice for the producer to collect the certificate bundles in one place and have the certificate bundles available to consumers at all times. In the example above, the producer would want all three certificates to be served in the namespace of/myapp/videos. In an application context, the producer and the consumer may agree on a common mechanism for serving and fetching the certificate bundle.

However, this approach may standardize a corresponding mechanism for reusability across the application, so a method that is implemented repeatedly for each application by a developer is an unnecessary burden on the developer. In addition, the approach developed at the application stage limits the scope of data usage. Consumers outside the context of the application cannot verify the data.

Another approach uses a directory service to host a certificate. This purpose may be accomplished using an NDN server which is a centralized key-value database. The certificate can be stored in a database using the name as the key and the content as the value. The subject executing the application as the producer can upload its certificate to an NDNS server using an out-of-band method. The consumer can query NDNS for all the certificates in the bundle.

This approach has the following problems.

First, publishing a certificate to a centralized service such as an NDN server requires privileges and is not a desirable option in certain practical use cases.

Second, a repeated query for the certificate is slow.

Third, there has been a problem that a user may feel uncomfortable due to structural limitations in extending to the scale of hosting all application certificates.

### SUMMARY OF THE INVENTION

The present disclosure is directed to a certificate proxy server framework that facilitates the development and arrangement of an NDN application.

The present disclosure is directed to a method for publishing a certificate capable of reducing a complicated authentication process in an ICN network.

The present disclosure is directed to a method and device for publishing a certificate capable of preventing an entire system from being down when an intermediate chain is down or a link is broken in an ICN network.

The present disclosure is directed to a method and device for publishing a certificate with which data verification can be performed even if an intermediate chain link is broken in an ICN network.

The present disclosure is directed to a method and device for publishing a certificate capable of preventing a data transmission delay at the time of occurrence of a delay when a certificate of a chain is fetched from another place in an ICN network.

Other objects and advantages of the present disclosure can be understood by the following description, and will be more clearly understood by the embodiments of the present disclosure. Furthermore, it will be readily apparent that the objects and advantages of the present disclosure may be realized by means of the instrumentalities and combinations thereof set forth in the claims.

According to an aspect of the present disclosure, there is served a certificate publishing method including: receiving an RPC message including an publishing method from a client; when the client includes request authority, generating a wrapper for each certificate of a bundle and storing the generated wrapper in a database; when the certificate is not a final certificate, initializing a location and counter of a next certificate to be fetched; transmitting a certificate fetching request from the location; when the certificate is a newly fetched certificate, updating the location of the certificate, incrementing a count variable, generating a certificate wrapper for the certificate, and adding the generated certificate wrapper to the database; and when the certificate is reliable, transmitting an RPC response message to the client.

In the certificate publishing method according to an embodiment of the present disclosure, the publishing method includes a certificate bundle, a final certificate, and a chain length requested by an issuer.

In the certificate publishing method according to an embodiment of the present disclosure, the initializing of the location and counter of the next certificate to be fetched may further include setting a location value of the next certificate as a key locator of the last certificate in the bundle.

The certificate publishing method according to an embodiment of the present disclosure may further include entering an end operation when the client does not include the request authority.

The certificate publishing method according to an embodiment of the present disclosure may further include transmitting the RPC response message to the client when the certificate is the final certificate.

The certificate publishing method according to an embodiment of the present disclosure may further include transmitting the RPC response message to the client when the certificate is not the newly fetched certificate.

The certificate publishing method according to an embodiment of the present disclosure may further include re-entering the transmitting of the fetching request to be fetched from the location when the certificate is unreliable.

In the certificate publishing method according to an embodiment of the present disclosure, the transmitting of the certificate fetching request from the location may further include, when an interest packet is received, extracting a last component of a name of the interest packet and considering the extracted last component as an ID of the requested certificate; requesting the certificate from a database component using the ID; encapsulating the certificate in the certificate wrapper; and setting a PID as a parent certificate ID of the certificate.

The certificate publishing method according to an embodiment of the present disclosure may further include transmitting the RPC response message to the client when the certificate is reliable, and transmitting the RPC response message to the client when the number of certificates reaches a maximum value.

A method for retrieving a certificate according to an embodiment of the present disclosure includes: receiving an RPC message including a retrieving method from a client; when the client has request authority, initializing a location and counter of a next certificate to be fetched and generating an empty set bundle; transmitting a certificate fetching request from the location; when the certificate is a newly fetched certificate, adding the certificate to a bundle, adding the certificate to the database, updating the location of the certificate, and incrementing a count variable; and when the certificate is reliable, transmitting an RPC response message to the client.

In the certificate retrieving method according to an embodiment of the present disclosure, the retrieving method may include a certificate name, a final certificate, and a chain length requested by an issuer.

In the certificate retrieving method according to an embodiment of the present disclosure, the initializing of the location and counter of the next certificate to be fetched and the generating of the empty set bundle may include setting a location value of the next certificate as a key locator of a last certificate in the bundle.

The certificate retrieving method according to an embodiment of the present disclosure may further include entering an end operation when the client does not include the request authority.

The certificate retrieving method according to an embodiment of the present disclosure may further include transmitting an RPC response message to the client when the certificate is not the newly fetched certificate.

The certificate retrieving method according to an embodiment of the present disclosure may further include re-entering the transmitting of the fetching request to be fetched from the location when the certificate is unreliable.

In the certificate retrieving method according to an embodiment of the present disclosure, the transmitting of the certificate fetching request from the location may further include, when an interest packet is received, extracting a last component of a name of the interest packet and considering the extracted last component as an ID of the requested certificate; requesting the certificate from a database component using the ID; encapsulating the certificate in the certificate wrapper; and setting a PID as a parent certificate ID of the certificate.

The certificate retrieving method according to an embodiment of the present disclosure may further include transmitting the RPC response message to the client, when the certificate is reliable, and transmitting the RPC response message to the client when the number of certificates reaches a maximum value.

A device for publishing a certificate according to an embodiment of the present disclosure may include: a communication unit configured to transmit and receive data to and from an external device; a database configured to store the data; and an RPC server configured to: receive an RPC message including an publishing method from a client through the communication unit; when the client includes request authority, generate a wrapper for each certificate in a bundle; store the generated wrapper in the database; when the certificate is not a final certificate, initialize a location and counter of a next certificate to be fetched; transmit a certificate fetching request from the location; when the certificate is a newly fetched certificate, update the location of the certificate, increment a counter variable, generate a certificate wrapper for the certificate, and add the certificate wrapper to the database; and when the certificate is reliable, transmit an RPC response message to the client.

According to an embodiment of the present disclosure, there is an advantage in that, although data always needs to be signed and authenticated in an ICN network, a failure of an authentication process or a transmission delay can be reduced.

According to an embodiment of the present disclosure, there is an advantage that an entire system shutdown in which the entire system does not operate when an intermediate chain is down or a link is broken in an ICN network is prevented.

According to an embodiment of the present disclosure, there is an advantage in that data verification can be performed even if an intermediate chain link is broken in an ICN network.

According to an embodiment of the present disclosure, there is an advantage that a data transmission delay that occurs when a certificate of a chain is fetched from another place in an ICN network is prevented.

The existing certificate processing method has limitations in serving a certificate bundle in a single location because namespaces are different, but according to an embodiment of the present disclosure, there is an advantage in that an issuer uses a wrapper mechanism to issue a certificate bundle with a single API regardless of namespace.

According to an embodiment of the present disclosure, there is an advantage in that a consumer can prevent a service failure due to one or more certificates in a key chain that cannot be retrieved.

According to an embodiment of the present disclosure, a producer and a consumer can search for a certificate in a single location rather than in multiple locations, thereby reducing a latency time and a bandwidth.

Effects obtainable in the present disclosure are not limited to the effects mentioned above, and other effects not mentioned may be clearly understood by those skilled in the art from the description below.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a certificate storage system according to an embodiment of the present disclosure;

FIG. 2 is a diagram illustrating an NDN certificate format according to an embodiment of the present disclosure;

FIG. 3 is a diagram illustrating an NDN certificate chain according to an embodiment of the present disclosure;

FIG. 4 is a diagram illustrating a format of an NDN certificate wrapper according to an embodiment of the present disclosure;

FIG. 5 is a diagram illustrating a new embodiment of an NDN certificate chain according to an embodiment of the present disclosure;

FIG. 6 is a diagram illustrating the structure of a certificate daemon according to an embodiment of the present disclosure;

FIG. 7 is a flowchart illustrating a method for publishing a certificate according to an embodiment of the present disclosure;

FIG. 8 is a flowchart illustrating a method for retrieving a certificate according to an embodiment of the present disclosure; and

FIG. 9 is a block diagram illustrating a certificate publishing device and a certificate retrieving device according to an embodiment of the present disclosure.

### DETAILED DESCRIPTION OF EXEMPLARY EMBODIMENTS

Hereinafter, with reference to the accompanying drawings, embodiments of the present disclosure will be described in detail so that those skilled in the art can easily carry out the present disclosure. However, the present disclosure may be implemented in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

In the present disclosure, the terms “first,” “second,” etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, when a component is referred to as being “coupled,” or “connected” to another component, it is understood that not only a direct connection relationship but also an indirect connection relationship through an intermediate component may be included. In addition, when a component is referred to as “comprising” or “having” another component, it does not mean that another component is excluded but in fact another component may be included unless explicitly described to the contrary.

On the other hand, when a component is referred to as “directly connected” or “directly connected” to another component, it should be understood that there is no other component between the components.

In addition, in the present disclosure, the description of each drawing may be applied to different drawings unless one drawing showing an embodiment of the present disclosure corresponds to another drawing and an alternative embodiment.

Hereinafter, the present disclosure will be described in detail with reference to the accompanying drawings.

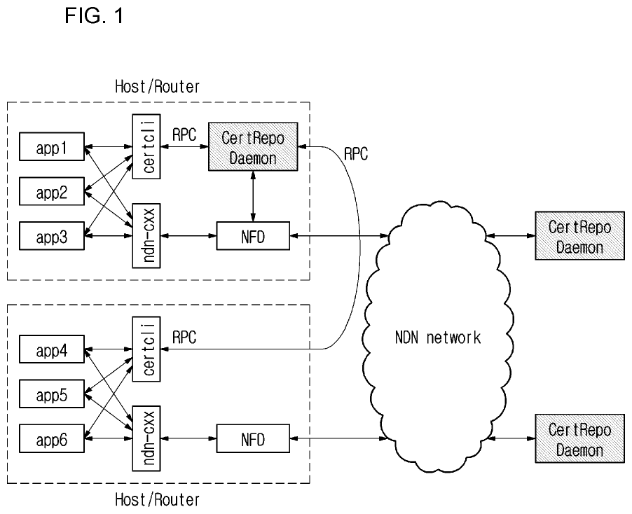

FIG. 1 is a block diagram illustrating a certificate storage system according to an embodiment of the present disclosure.

As illustrated in FIG. 1, the proposed system includes a certificate storage server executed in an NDN node of an NDN network. The node may be an NDN host or a router. The server may be executed with a system daemon service on a node that owns a namespace. The service name is a certificate repository (CertRepo), which is an NDN producer that serves a certificate of its own namespace to another certificate server on the network. To host the certificate in a user designated namespace, a new data format is introduced in the form of NDN data packets to wrap certificate content.

The main role of CertRepo is to act as a proxy agent on behalf of an NDN application program in two functions of serving a certificate bundle and retrieving the certificate. These functions are implemented as a remote procedure call (RPC) that a client can call. The client is an NDN application program. The client interacts with CertRepo through an RPC client library called certcli. When a producer wants to serve a certificate bundle to a consumer, the producer may request that the relevant CertRepo act on its behalf. The server may retrieve a missing certificate from the network and serve a corresponding bundle in one place. When a consumer wants to retrieve the certificate bundle for data validation, the consumer may request that the relevant CertRepo act on its behalf. The server may collect the bundle's certificates by searching for the certificates in a database or retrieving the certificates from the network.

The certificate wrapper will be described.

This section will describe an NDN certificate format and a certificate bundle. After that, a certificate wrapper format that can be used to encapsulate certificates served by CertRepo in a user-defined namespace will be introduced. The certificate wrapper format ends with an example showing a method for CerRepo to issue and search for a certificate bundle for an NDN application program by utilizing this new format.

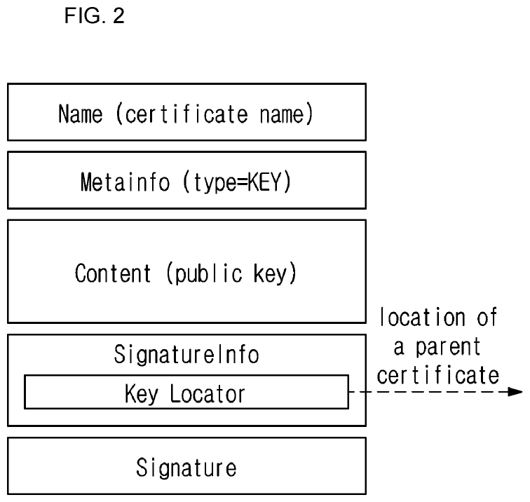

FIG. 2 is a diagram illustrating an NDN certificate format according to an embodiment of the present disclosure.

A certificate binds a public key and a namespace, which are signed by certificate authority (CA). An NDN certificate is also a data packet whose structure is shown in FIG. 2. The name of the packet is also the name of the certificate.

The packet name follows the following format:

/{subject-identity}/KEY/{key-identity}/{issuer-identity}/{ver}

A subject ID is a namespace that identifies the owner of a certificate.

A key ID is a short string ID of a public key contained in a certificate, usually defined by the certificate owner.

An issuer ID is a unique ID of a certificate signer defined by the certificate owner. The element of ver is optional and indicates a certificate version.

The element of MetaInfo must indicate that the content of the packet is a public key. The element of Content contains a public key in X.509 standard format. SignatureInfo includes the element of Key Locator that serves a pointer for the validity period of the certificate and other certificates. The element of Signature contains the signature of the certificate.

The value of Key Locator may be either a digest or a name. When the value of Key Locator is the digest value, the interpretation varies according to an application program. Otherwise, the value of Key Locator indicates a place where a parent certificate is served.

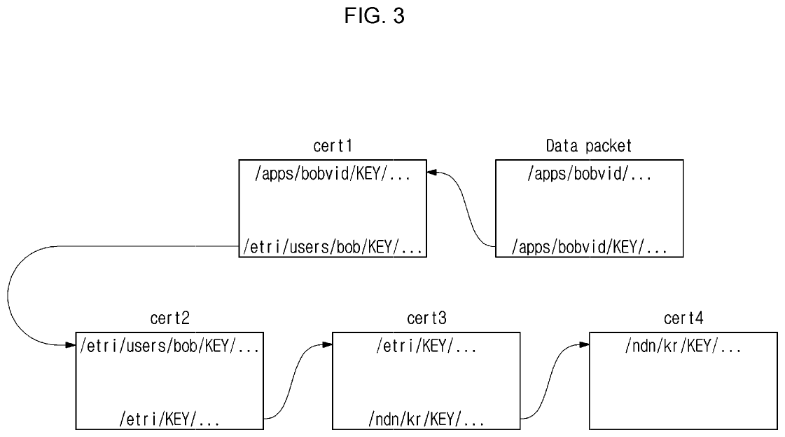

FIG. 3 is a diagram illustrating an NDN certificate chain according to an embodiment of the present disclosure.

A certificate binds together a certificate chain defined within application context. The chain starts with a certificate used to validate application data. The chain ends with a reliable anchor. A data packet in the corresponding context is valid when the following two conditions are met. The connected certificate bundle is valid. The packet's signature may be identified with a public key of the first certificate in the bundle.

FIG. 3 shows an example of a data verification chain. A producer serves a data packet of a namespace/apps/bobvid to a consumer. The signature of the data packet is identified with a public key of certificate cert1 (/apps/bobvid/KEY/ . . . ). The certificate cert1 starts a certificate chain ending in certificate cert4. Assuming cert4 as a reliable anchor, the consumer should collect all remaining certificates and identify that the certificates are all valid before identifying the data packet.

The above chain cannot be served from the producer's namespace (e.g. /apps/bobvids). Instead, the chain may be distributed across three namespaces: /apps/bobvids, /etri, and/ndn/kr. When the corresponding certificate cannot be fetched from one of these namespaces, a data identification process is terminated.

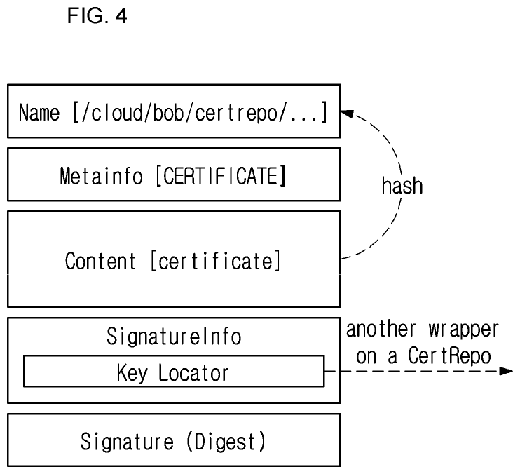

FIG. 4 is a diagram illustrating a format of an NDN certificate wrapper according to an embodiment of the present disclosure.

Since a certificate name indicates a location where the certificate is served, a certificate wrapper is required to host the certificate name in a user designed namespace. A wrapper is a data packet whose content encapsulates a certificate. The structure of the packet along with a description of the corresponding element is shown in FIG. 4.

The packet name is defined as {repo-name}/certrepo/{certificate-identity}. Here, repo-name is an NDN namespace of a repository in which a certificate is served. Certificate-identity is a fixed-length hexadecimal string indicating the identity of the certificate.

The ID is defined as a hash value (SHA256) of the binary connection of a subject ID, key ID, and issuer ID of the certificate. This information can be extracted from the certificate name.

The element of Metainfo is set as an integer (CERTIFICATE) indicating that the packet content is the certificate. The element of Content is set as the certificate.

In the application program context, a certificate wrapper is valid when it is bound to a valid certificate. Binding is implicitly displayed by configuration. Certificate ID (contained in a wrapper name).

Therefore, the wrapper does not need to be protected with a signature, so the signature element is replaced with digest. However, the element of Key Locator within the element of SignatureInfo can be used to establish a link for another wrapper that encapsulates the certificate's parent. The corresponding value is the NDN name of the connected wrapper. Accordingly, when the parent certificate is not hosted on CertRepo, it is necessary to fetch the parent certificate with a corresponding name.

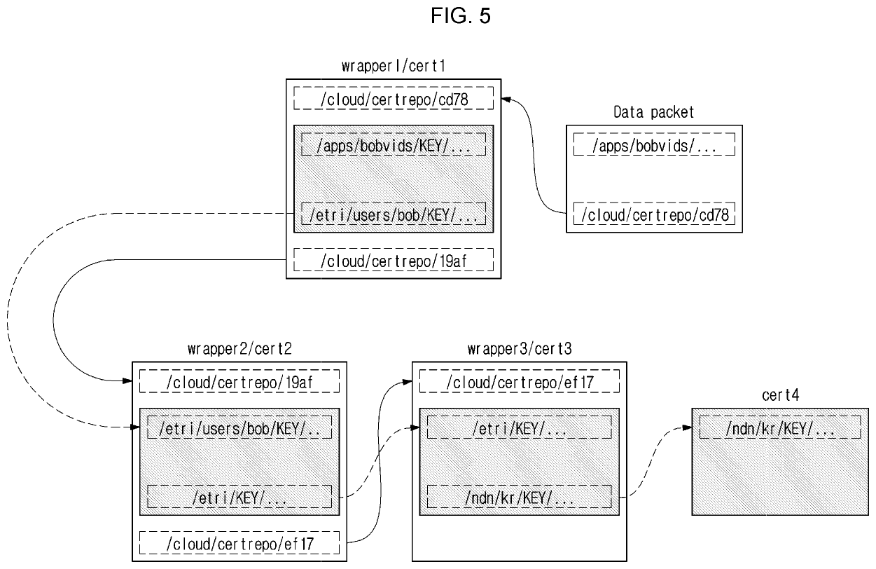

FIG. 5 is a diagram illustrating a new embodiment of an NDN certificate chain according to an embodiment of the present disclosure.

This section provides an example of a method in which CertRepo uses the concept of a certificate wrapper to support an NDN application program that serves and searches for a certificate bundle. In FIG. 5 the same producer of FIG. 3 would like to serve certificate bundles in one place so that a consumer can retrieve the certificate bundles at once. It is possible to rely on CertRepo in/cloud to host the bundle. CertRepo may be executed in the same namespace as the producer (e.g. /apps or/apps/bob).

For some reasons, the producer may determine that the last certificate in a bundle cert4 should not be included. This is because the bundle cert4 is reliably hosted on an NDN server. Accordingly, it is possible to request that CertRepo collect certificates cert1, cert2 and cert3 and serve the certificates to the consumer. The request may include the first certificate cert1 and the name of the last certificate cert3 in the chain. CertRepo is responsible for fetching the remaining the certificates cert2 and cert3 of the chain.

When signing a data packet, the producer sets the element of Key Locator of the packet as the wrapper name of the first certificate cert1. On the other hand, when the data packet is received, the consumer makes the request using key locator information of a packet (/cloud/certrepo/cd78) and a reliable anchor (/ndn/kr/KEY/ . . . ). A certificate bundle is retrieved by transmitting the data packet to CertRepo. This CertRepo may be different than that executed in/cloud/certrepo. CertRepo needs to follow the link of the certificate chain as shown in FIG. 5 to fetch all the wrappers. Finally, it is possible to respond to the consumer request with the certificate bundle as shown in FIG. 3.

An RPC client library will now be described.

A certificate repository client library provides an interface for an NDN application program to communicate with a certificate repository server. The server may be executed on a local host or a remote host. The interface may be implemented as a set of RPCs, and client-server message delivery may be implemented with a variety of transport protocols. All implementations of the present disclosure must specify the format of an RPC message and a corresponding encoding/decoding method.

The server may implement an access control policy that can grant specific permission for a client to execute an RPC. Here, the client is an application program that communicates with a daemon using an RPC client library. To do this, the client is registered in the server using credentials. However, in the present disclosure, policies for registration mechanism and access control are not defined. Therefore, client-server message communication should provide a means for the server to activate the access control policy.

The client library is required to implement two RPCs: 1) publishing certificate and 2) retrieving certificate. The client library may also include other RPCs such as certificate query and certificate deletion to meet the needs of the corresponding application program. A certificate data structure represents an NDN certificate and a bundle data structure represents a chain of certificate entities. The two RPCs are then defined in the next section.

Publishing a certificate will now be described.

This method is implemented by including a certificate bundle on the server. The client transmits a request that the server store a list of certificates to serve the certificate list to the client's consumer. The server executes this method and responds to the client with the execution result.

PUBLISH(bundle Bundle, anchor string, maxdepth int) error

An acquisition list of the method includes a certificate bundle (bundle), an ID string (anchor) of a root anchor, and an integer maxdepth indicating the maximum number of certificates the server can fetch to fulfill the request.

Upon receiving the request, the server is required to store all certificates in the bundle in a database to serve the certificates to the network.

When the string anchor is not empty, the server recursively fetches other certificate chains connected to the last certificate of the bundle when the key locator is an anchor or until reaching a certificate in which the length of a fetched chain exceeds maxdepth.

When an acquisition anchor is empty, only the certificate of the bundle is issued. In this method, it is required to return an error entity indicating the final status of certificate issuance and the error entity is required to be included in a response message to the client.

Certificate retrieving will now be described.

This method includes implementing certificate bundle fetching. The client sends a request for a bundle to the server. The server executes this method to prepare the bundle and returns the bundle to the client as a response message.

RETRIEVE(certname string, anchor string, maxdepth int) Bundle, error

The acquisition list of the method includes a certificate name (certname), a reliable anchor name (anchor), and an integer indicating the maximum number of certificates served by the server.

Authentication certname is usually the name of a certificate for identifying a data packet received from the application program of the client.

Authorization anchor is the name of the reliable anchor. Two strings may define the certificate bundle that the client's application should use with a security model to identify received data. When only a single certificate is to be fetched, the authentication anchor should be empty.

Upon receiving the request, the server should prepare a certificate bundle to respond to the client. The bundle is a certificate chain encoded as an RPC response such as gRPC, SOAP, JSON-RPC, etc. An RPC message is usually provided in a format that is easy for a caller to use through marshalling and unmarshalling. During preparation, the server may need to fetch some certificates and store them in the database in order to process subsequent requests from other clients. The response message should include a bundle indicating the certificate bundle preparing status and an error entity.

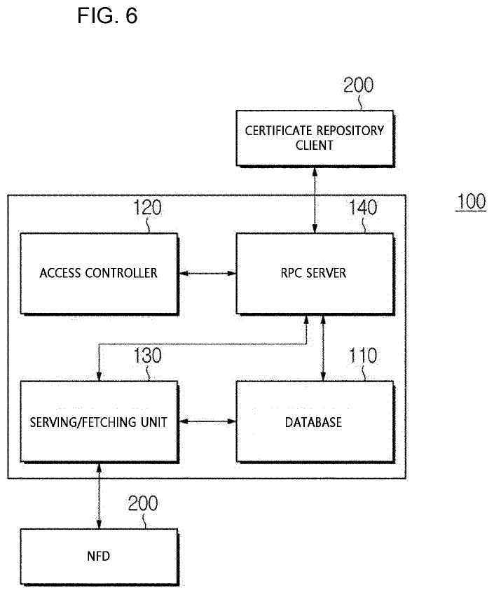

FIG. 6 is a diagram illustrating the structure of a certificate daemon according to an embodiment of the present disclosure.

A certificate repository 100 will now be described. The certificate repository may be any one of a certificate publishing device and a certificate retrieving device.

The certificate repository may be executed as a daemon service on an NDN host. This has the following two main functions: serving a certificate to a public network; and client request processing for certificate issuance and certificate retrieval. In the following section, common components of a repository daemon and main logic for implementing functions of the components will now be described.

As illustrated in FIG. 6, the certificate repository 100 includes a database 110, an access control 120, a serving/patching unit 130, and an RPC server 140.

The database 110 maintains a list of certificates for services.

The database 110 collects certificates while processing client requests for certificate issuance and certificate retrieval. The component may be a persistent database and may be accompanied by an in-memory cache for fast access. It is necessary to expose two basic elements: a put method of storing the certificate in the database, and a get method of retrieving the certificate by ID.

The access controller 120 maintains a list of registered clients and corresponding credentials, and repository usage permission. This allows the daemon to implement access control policies while an RPC server component is processing a client request.

The serving/fetching unit 130 implements two methods: a processing method of processing an NDN interest packet for the certificate request and a fetching method for a locator of downloading a designated certificate. The latter method is used exclusively by the RPC server component while processing the request of the repository client.

The RPC server 140 implements the processing method for the client RPC request to issue or retrieve the certificate by the daemon.

Serving a certificate will now be described.

All certificates in the local database of the certificate repository may be served to a public network. Hostname is set as an NDN name of a host where a repository daemon is located. The daemon may be executed as an NDN producer to serve all interest packets whose names start with a prefix of/host-name/certrepo. A procedure for processing the certificate request implemented in the serving/fetching unit 130 is as follows.

First, upon receiving the interest packet, the last component of the name is extracted and assumed to be the identity of the requested certificate.

Second, the certificate is queried from the database component by using ID. It is assumed that c is a certificate.

Third, c is encapsulated in certificate wrapper w, which is an NDN data packet. The packet name should be identical to the name of the interest packet.

Fourth, a PID is set as a parent certificate ID of c. The PID may be inferred from the element of Key Locator of c. When the PID is found in the database 110, the element of Key Locator of w should be set as the PID. This is so that the consumer can retrieve the parent of c at the same location. Otherwise, the element of Key Locator of c is empty. In this case, the consumer should retrieve the parent of c using key locator information in c. Finally, data packet w is sent back to the consumer.

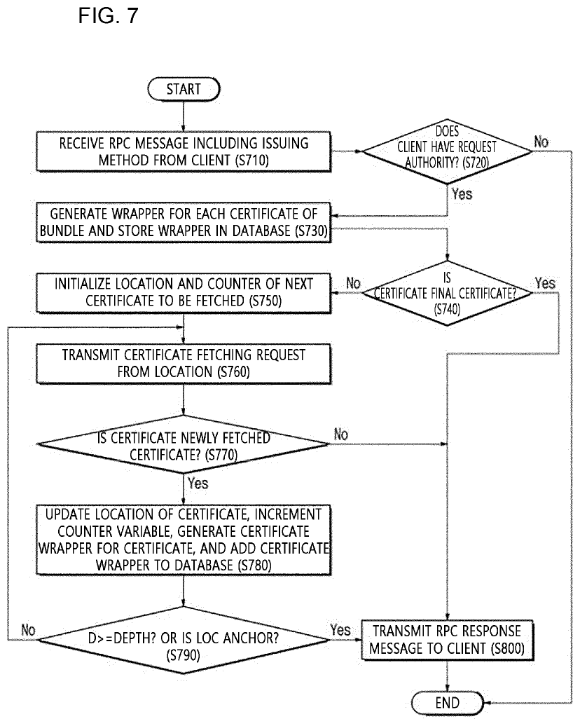

FIG. 7 is a flowchart illustrating a method for publishing a certificate according to an embodiment of the present disclosure. The method according to the present disclosure is performed by a certificate publishing device.

Publishing a certificate will now be described.

In this section, the main logic of the certificate repository for processing a client's request for publishing a certificate will be explained. This is implemented in an RPC server module of the repository daemon. Typically, when receiving an RPC request to issue a certificate, the repository not only stores the certificate sent by the client, but also fetches all the certificates to complete a key chain ending at a designated reliable anchor.

A pseudocode flowchart below shows a general flow of processing a single RPC call for publishing a certificate.

As illustrated in FIG. 7, in operation S710, an RPC message including an publishing method is received from the client.

Specifically, the RPC server waits to receive the RPC message including a method called PUBLISH (bundle, anchor, depth). The meaning of method acquisition was described in the previous section. It is assumed here that the RPC message has been successfully parsed.

In operation S720, whether the client has request authority is determined.

Specifically, the RPC message is required to include credentials of the client so that the server can authenticate the credentials via the access control component.

When the client includes the request authority in operation S720, in operation 730, a certificate wrapper for each certificate of the bundle is generated and the generated wrapper is stored in the database.

When the client does not include the request authority in S720, the message is not processed and the method ends.

In operation 740, whether the certificate is the final certificate is determined.

When the certificate is the final certificate in operation S740, in operation S800, an RPC response message is transmitted to the client.

Specifically, an anchor variable is empty. This means that more certificates are required to be issued. The corresponding algorithm proceeds to S800.

When the authenticator is not the final certificate in operation S740, in operation S750, the location and counter of the next certificate to be fetched are initialized.

Specifically, the location loc and counter d of the next certificate to be fetched are initialized. The value of loc is set as the key locator of the last certificate in the bundle.

In operation S760, a certificate fetching request is transmitted from the location.

Specifically, a certificate ID is inferred from loc and then used to request the existence of the certificate in the database. When the certificate is retrieved from the local database, the certificate should not be fetched from the network. Otherwise, the fetching request is transmitted to retrieve the certificate from location loc. Here, c is the certificate to be fetched.

In operation S770, whether the certificate is a newly fetched certificate is determined.

When the certificate is not the newly fetched certificate in operation S770, in operation S800, an RPC response message is transmitted to the client.

When the certificate is the newly fetched certificate in operation S770, in operation S780, the location of the certificate is updated, a count variable is incremented, a certificate wrapper for the certificate is generated, and the generated certificate wrapper is added to the database.

Specifically, when certificate c is the newly fetched certificate, a certificate wrapper is generated from c and then the certificate wrapper is added to the database. The counter variable d is incremented and the location of the next certificate to be fetched is updated to loc. When c is included in a wrapper retrieved from an internal database in operation S760, the value of loc should be the wrapper's key locator value. Otherwise, the value of loc should be a key locator value of the certificate.

When the certificate is an anchor in operation S790, in operation S800, an RPC response message is transmitted to the client.

Specifically, when the certificate is the anchor or the number of the retrieved certificates reaches the maximum number, the loop is broken and the algorithm enters operation S800.

In operation S800, the certificate issuance status has been updated in the previous operation. The RPC response message including the status is transmitted back to the client. The request processing is then finished and the server may return to the start operation to wait for the next RPC request message.

When the certificate is not the anchor in operation S790, the algorithm re-enters operation S760.

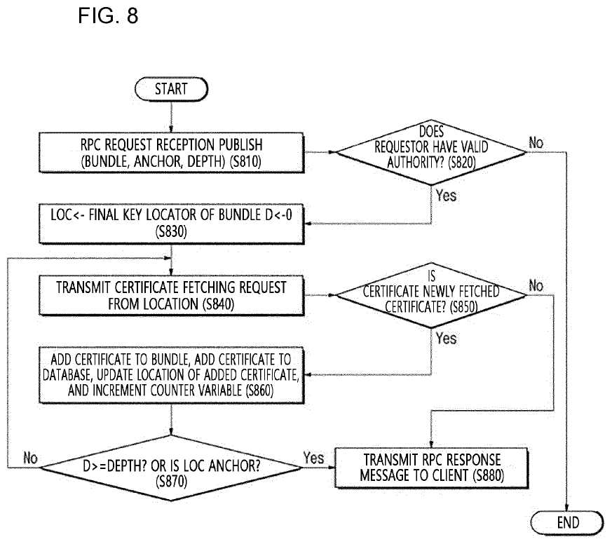

FIG. 8 is a flowchart illustrating a method for retrieving a certificate according to an embodiment of the present disclosure. The present disclosure is performed by a certificate retrieving device.

In this section, the main logic of the certificate repository for processing a client's request to retrieve a certificate bundle will be explained. This is implemented in the RPC server module of the repository daemon. Generally, upon receiving an RPC request to retrieve the certificate bundle, the repository recursively fetches all certificates and returns the bundle as a response message. A pseudocode flowchart below shows a general flow of processing a single RPC call to retrieve a certificate bundle.

As illustrated in FIG. 8, in operation S810, an RPC message including a recall method is received from a client.

Specifically, the RPC server waits to receive the RPC message including a RETRIEVE (certname, anchor, depth) method call. The meaning of method acquisition was described in the previous section. Here, it is assumed that the RPC message has been successfully parsed.

In operation S820, whether the client has request authority is determined.

Specifically, the RPC message is required to include the client's credentials so that the server may authenticate the credentials through the access control component.

When the client includes the request authority in operation S820, the location and counter of the next certificate to be fetched are initialized and an empty set bundle is generated in operation S830.

Specifically, before entering a main loop, the location of the certificate to be retrieved next is set as a variable loc, the counter d is initialized, and the empty set bundle is generated to collect the retrieved certificates.

When the client does not include the request authority in operation S820, an RPC response message is transmitted to the client in operation S880.

A certificate fetching request is transmitted from the location in operation S840.

Specifically, a certificate ID is inferred from loc and then used to query the existence of the certificate in the database. When the certificate is retrieved from the local database, the certificate should not be fetched from the network. Otherwise, the fetching request is transmitted to retrieve the certificate from location loc. It is assumed that c is a certificate to be fetched. A loc variable can be either the certificate name or the name of the certificate wrapper, so a data packet to be returned may be the certificate or certificate wrapper.

Whether the certificate is a newly fetched certificate is determined in operation S850.

When the certificate is not the newly fetched certificate in operation S850, an RPC response message is transmitted to the client in operation S880.

Specifically, when the certificate is an anchor or the number of the retrieved certificates reaches the maximum number, the loop is stopped and the algorithm enters operation S880.

In operation S880, an error should be recorded to indicate that all required certificates from the bundle have been retrieved or failed to be retrieved in the previous operation. An RPC response message containing the bundle and error message is transmitted back to the client. The request processing is then finished, and the server may return to the start operation to wait for the next RPC request message.

When the certificate is not the anchor in operation S870, the algorithm re-enters operation S840.

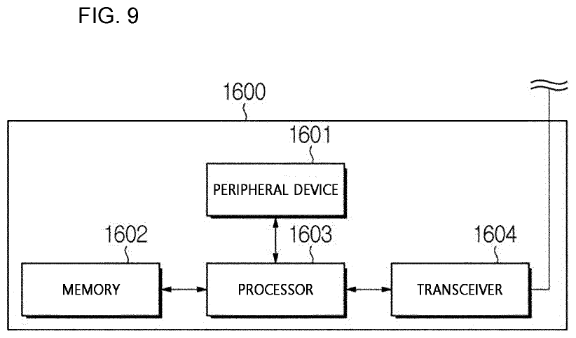

FIG. 9 is a block diagram illustrating a certificate publishing device and a certificate retrieving device according to an embodiment of the present disclosure.

An embodiment of the certificate publishing device and the certificate retrieving device may be a device 1600. Referring to FIG. 9, the device 1600 may include a memory 1602, a processor 1603, a transceiver 1604, and a peripheral device 1601. In addition, as an example, the device 1600 may further include other components, and is not limited to the above-described embodiment.

More specifically, the device 1600 of FIG. 10 may be an exemplary hardware/software architecture such as a certificate publishing device and a certificate retrieving device. At this time, for example, the memory 1602 may be a non-removable memory or a removable memory. In addition, as an example, the peripheral device 1601 may include a display, a GPS, or other peripheral devices, and is not limited to the above-described embodiment.

In addition, as an example, the above-described device 1600 may include a communication circuit such as the transceiver 1604, and based on this, may communicate with an external device.

In addition, as an example, the processor 1603 may be at least one or more of a general purpose processor, a digital signal processor (DSP), a DSP core, a controller, a microcontroller, application specific integrated circuits (ASICs), field programmable gate array (FPGA) circuits, any other type of integrated circuit (IC) and one or more microprocessors associated with a state machine. That is, the processor 1603 may be a hardware/software configuration that performs a control role of controlling the device 1600 described above.

In this case, the processor 1603 may execute computer executable instructions stored in the memory 1602 to perform various essential functions of the certificate publishing device and the certificate retrieving device. For example, the processor 1603 may control at least one of signal coding, data processing, power control, input/output processing, and a communication operation. In addition, the processor 1603 may control physical layers, MAC layers, and application layers. In addition, as an example, the processor 1603 may perform authentication and security procedures in access layers and/or application layers, and is not limited to the above-described embodiment.

For example, the processor 1603 may communicate with other devices through the transceiver 1604. For example, the processor 1603 may control the certificate publishing device and the certificate retrieving device to communicate with other devices through a network through the execution of the computer executable instructions. That is, the communication performed in the present disclosure may be controlled. For example, the transceiver 1604 may transmit an RF signal through an antenna and may transmit signals based on various communication networks.

In addition, the antenna technology is not limited to that of the above-described embodiment, and as an example, MIMO technology, beamforming, etc., may be applied. In addition, the signals transmitted and received through the transceiver 1604 may be modulated and demodulated and controlled by the processor 1603, and are not limited by the above-described embodiment.

Various embodiments of the present disclosure are intended to explain representative aspects of the present disclosure rather than listing all possible combinations, and matters described in various embodiments may be applied independently or in combinations of two or more.

In addition, various embodiments of the present disclosure may be implemented by hardware, firmware, software, or a combination thereof. For implementation by hardware, implementation may be performed by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, or the like. For example, it is obvious that the implementation may be performed in the form of a program stored in a non-transitory computer readable medium that can be used at the end or at the edge, or in the form of a program stored in a non-transitory computer readable medium that can be used at the edge or in the cloud. In addition, the implementation may be performed with a combination of a variety of hardware and software.

The scope of the present disclosure includes software or machine-executable instructions (e.g., operating systems, applications, firmware, programs, etc.) that cause operations according to the method according to various embodiments to be executed on a device or computer, and a non-transitory computer-readable medium in which such software and instructions are stored and executable on a device or computer.

The aforementioned present disclosure is not limited to the aforementioned description, and it will be obvious to a person of ordinary skill in the art that various substitutions, modifications, and changes are possible within the scope not departing from of the technical spirit of the present disclosure, and the scope of the present disclosure is not limited by the foregoing embodiments or the accompanying drawings.

What is claimed is:

1. A method for publishing a certificate in an ICN network, the method comprising:
receiving an RPC message including a publishing method from a client;
when the client includes request authority, generating a wrapper for each certificate of a bundle and storing the generated wrapper in a database;
when the certificate is not a final certificate, initializing a location and counter of a next certificate to be fetched;
transmitting a certificate fetching request from the location;
when the certificate is a newly fetched certificate, updating the location of the certificate, incrementing a count variable, generating a certificate wrapper for the certificate, and adding the generated certificate wrapper to the database; and
when the certificate is reliable, transmitting an RPC response message to the client.

2. The method of claim 1, wherein the publishing method includes a certificate bundle, a final certificate, and a chain length requested by an issuer.

3. The method of claim 1, wherein the initializing of the location and counter of the next certificate to be fetched further includes setting a location value of the next certificate as a key locator of the last certificate in the bundle.

4. The method of claim 1, further comprising entering an end operation when the client does not include the request authority.

5. The method of claim 1, further comprising transmitting the RPC response message to the client when the certificate is the final certificate.

6. The method of claim 1, further comprising transmitting the RPC response message to the client when the certificate is not the newly fetched certificate.

7. The method of claim 1, further comprising re-entering the transmitting of the fetching request to be fetched from the location when the certificate is unreliable.

8. The method of claim 1, wherein the transmitting of the certificate fetching request from the location further includes
when an interest packet is received, extracting a last component of a name of the interest packet and considering the extracted last component as an ID of the requested certificate;
requesting the certificate from a database component using the ID;
encapsulating the certificate in the certificate wrapper; and
setting a PID as a parent certificate ID of the certificate.

9. The method of claim 1, further comprising:
transmitting the RPC response message to the client when the certificate is reliable; and
transmitting the RPC response message to the client when the number of certificates reaches a maximum value.

10. A method for retrieving a certificate, the method comprising:
receiving an RPC message including a retrieving method from a client;
when the client has request authority, initializing a location and counter of a next certificate to be fetched and generating an empty set bundle;
transmitting a certificate fetching request from the location;
when the certificate is a newly fetched certificate, adding the certificate to a bundle, adding the certificate to data, updating the location of the certificate, and incrementing a count variable; and
when the certificate is reliable, transmitting an RPC response message to the client.

11. The method of claim 10, wherein the initializing of the location and counter of the next certificate to be fetched and the generating of the empty set bundle include setting a location value of the next certificate as a key locator of a last certificate in the bundle.

12. The method of claim 10, further comprising entering an end operation when the client does not include the request authority.

13. The method of claim 10, further comprising transmitting an RPC response message to the client when the certificate is not the newly fetched certificate.

14. The method of claim 10, further comprising re-entering the transmitting of the fetching request to be fetched from the location when the certificate is unreliable.

15. The method of claim 10, wherein the transmitting of the certificate fetching request from the location further includes,
when an interest packet is received, extracting a last component of a name of the interest packet and considering the extracted last component as an ID of the requested certificate;
requesting the certificate from a database component using the ID;
encapsulating the certificate in the certificate wrapper; and
setting a PID as a parent certificate ID of the certificate.

16. The method of claim 10, further comprising:
transmitting the RPC response message to the client when the certificate is reliable; and
transmitting the RPC response message to the client when the number of certificates reaches a maximum value.

17. A device for publishing a certificate, the device comprising:
a communication unit configured to transmit and receive data to and from an external device;
a database configured to store the data; and
an RPC server configured to:
receive an RPC message including an publishing method from a client through the communication unit;
when the client includes request authority, generate a wrapper for each certificate in a bundle;
store the generated wrapper in the database;
when the certificate is not a final certificate, initialize a location and counter of a next certificate to be fetched;
transmit a certificate fetching request from the location;
when the certificate is a newly fetched certificate, update the location of the certificate, increment a counter variable, generate a certificate wrapper for the certificate, and add the certificate wrapper to the database; and
when the certificate is reliable, transmit an RPC response message to the client.
